(19) United States
(12) Patent Application Publication
(10) Pub. No.: US 2007/0024438 A1
(43) Pub. Date: Feb. 1, 2007

(54) Portable radar alarm device having water and weather resistance

(76) Inventor: Mike Chen, Irvine, CA (US)

Correspondence Address: Mike Chen, 3620 168th St. apt 3D, Flushing, NY, 11358, US

(21) Appl. No.: 11/193,066

(22) Filed: Aug. 1, 2005

(51) Int. Cl. H04Q 7/00

(52) U.S. Cl. 340/539.11

(57) ABSTRACT

The present invention provides an improving design of a portable radar alarm device that comprises a cover body and a launching device. The portable radar alarm device of the present invention sorts out those defects of the conventional alarm device. The present invention provides the portable radar alarm device controlled by a re-set remote-control device can be setup quickly and easily at a location of outdoor sports or wildlife activities. Once the sensor of the alarm device senses any abnormal condition, a warning signal will be sent to a user to warn the potential danger. Thus, the present invention provides an improving design of an alarm device that is more practical to accompany the needs of outdoor activities, is convenient to use and easy to setup and position the device.

### BACKGROUND OF THE INVENTION

1. Field of Invention

The present invention relates to a portable radar alarm device having water and weather resistance. More particularly, the present invention relates to an alarm device that is utilized to sense conditions of outdoor or wildlife activities or sports and once it detects any abnormal condition, it sends out a warning signal to a user.

2. Description of the Related Art

The conventional alarm device is normally utilized and position at a fixed location, such as at the corner of a wall. The conventional alarm device comprises a sensor and a sounding unit, the alarm device utilizes its sensor to sense whether there is any object approaching, and then sends out a warning signal to the user.

Although the conventional alarm device can utilize its sensor to sense whether there is any object approaches or not, and it sends out a warning signal to the user. However, the alarm device can only be fixed on a specific location and once its location is fixed, it is difficult to alter the location and it cannot be removed easily. Furthermore, those conventional alarm devices on the market are utilized the electrical wire connected to an electrical source in order to supply its power. If there is blackout, the alarm devices cannot be used continuously. Moreover, the conventional alarm device also cannot be altered its position easily once it is setup in a particular position. Thus, it creates blind spots once someone is familiar with its location and easily escapes the detective range of the alarm device. As a result, the present invention provides an improving design of an alarm device that can overcomes those defects and is suitable utilized for outdoor or wildlife activities or sports, such as camping, outdoor BBQ or wildlife/Safari activities. Those outdoor activities sometime induces unforeseeable danger such as an attack from a perpetrator or a wild animal, therefore, the alarm device of the present invention not only can provide some sort of security which is not necessary can be achieved easily by the security guards or police officers, it also suitable to be used according to the conditions of the outdoor activities.

### SUMMARY OF THE INVENTION

It is an object of the present invention to provide an alarm device controlled by a remote-control device that can be utilized for outdoor or wildlife activities or sports either by placing on a surface of the ground or hanging on a top portion of the tent or hanging on a tree. The alarm device of the present invention can provide a wider range of detecting area and once it senses any abnormal condition, a warning signal is sent out to the user to aware the danger of a wild animal or an intruder.

It is another object of the present invention to provide an improving design of a portable radar alarm device that sorts out those defects of the conventional alarm device. The present invention provides an alarm device that is suitable to be used for outdoor or wildlife activities by sensing any abnormal condition and sending warning signals to the user for the potential danger.

The present invention provides an alarm device controlled by a re-set remote-control device which can be setup quickly and easily at any location of outdoor sports or wildlife activities. Once the sensor of the alarm device senses any abnormal condition, a warning signal will be sent to the user to warn the potential danger. Thus, the present invention provides an improving design of an alarm device that is more practical to accompany the needs of outdoor activities, it is convenient to use and easy to setup.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a prospective view of a remote-control device of a preferred embodiment of the present invention.

FIG. 2 is a 3-D assembled view of the remote-control device of the preferred embodiment of the present invention.

FIG. 3 is a prospective view of an alarm of a preferred embodiment of the present invention.

FIG. 4 is a 3-D assembled view of the alarm of the preferred embodiment of the present invention.

FIG. 5 is an environmental view of a practical example utilizing the alarm devices of the present invention.

### DESCRIPTION OF THE PREFERRED EMBODIMENTS

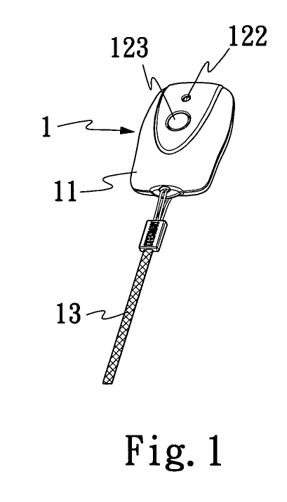

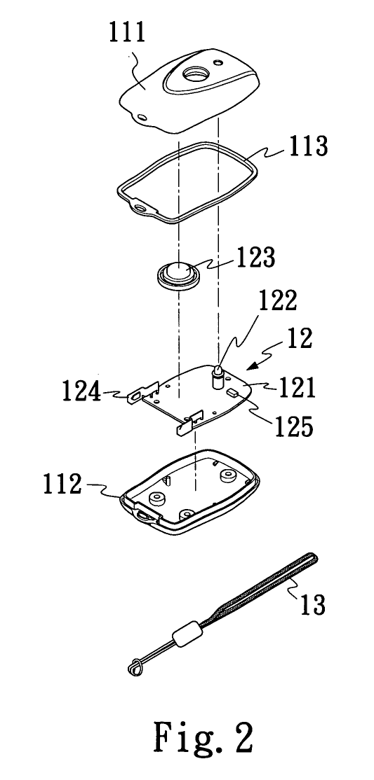

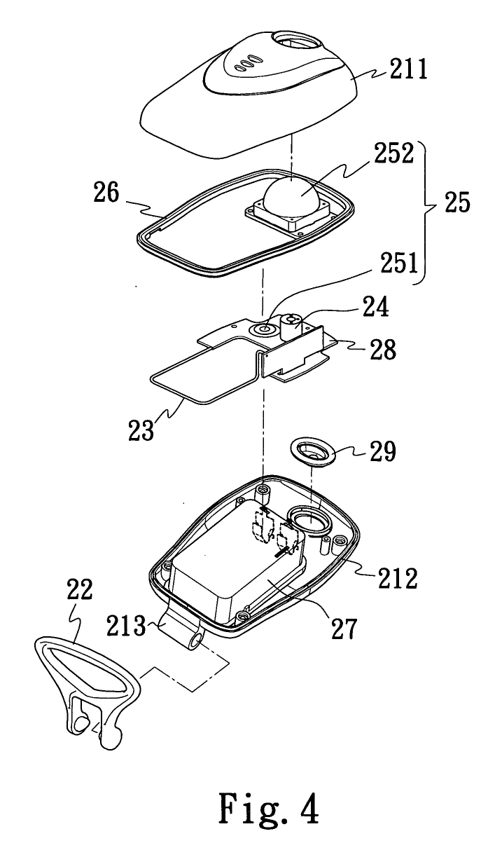

Refer to FIGS. 1, 2, 3 and 4 showing the 3-D prospective views of a remote-control device of a preferred embodiment of the present invention. A portable radar alarm apparatus of present invention having water and weather resistant, the apparatus comprises a remote-control device 1 and at least an alarm device 2. The alarm device 2 is set up and controlled by the remote-control device 1 and is positioned a location where a user is involved in outdoor or safari/wildlife activities or sports. A warning signal will alter the user of the danger when the device detects any abnormal object or an unusual condition of the outdoor environment.

The remote-control device 1 comprises a cover body 11 and a launching device 12 located within the cover body 11, wherein the launching device 12 can project an established signal. The cover body 11 of the remote-control device 1 comprises an upper cover 111 and a bottom cover 112, wherein a waterproof ring 113 is located in between the upper cover 111 and the bottom cover 112. The launching device 12 comprises an electrical circuit 121, wherein on a top surface of the electrical circuit 121 comprises a launching unit 125, an illuminated body 122, a key unit 123 and an electrical source 124. The key unit 123 and the illuminated body 122 are both exposed outside a top surface of the cover body 111, and a hooking ring 13 is formed on one end of the cover body 111 of the remote-control device 1. The design of the above-mentioned waterproof ring 113 located within the remote-control device1 is to allow the remote-control device 1 having the function of the water and weather resistances.

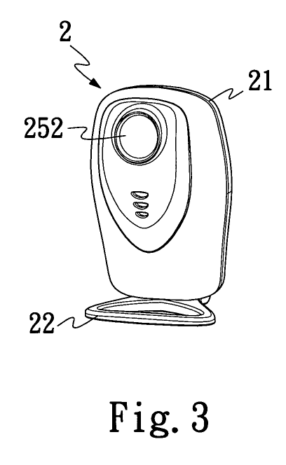

Refer to FIG. 3, an alarm device 2 comprises a supporting stand 22 and a cover body 21, wherein the supporting stand 22 is located at one end of the cover body 21. A receiver 23 is located in the cover body 21 and is utilized to receive signals sent by the above-mentioned launching unit 12. A sensor 24 and a warning unit 25 located inside the cover body 21 are utilized to sense the outdoor conditions and send a warning signal if detecting any abnormal condition. The alarm device 2 of the cover body 21 further comprises an upper cover 211 and a bottom cover 212. A waterproof ring 26 is formed in between the upper cover 211 and the bottom cover 212. A connecting portion 213 is formed at one end of the bottom cover 212 and is utilized to connect to the supporting stand 22. An electrical source 27 is located on the bottom cover 212 of the cover body 21 and is connected to the receiver 23, the sensor 24 and the warning unit 25, wherein the receiver 23, the sensor 24 and the warning unit 25 are positioned on an electrical circuit board 28. The electrical circuit board 28 is controlled by a pressed switch 29. The sensor 24 is utilized a method of thermal reaction to sense and determine the outdoor conditions. The warning unit 25 is comprised with an alarm unit 251 and an illuminated body 252. The design of the above-mentioned waterproof ring 26 of the present invention is to provide a structure of radar warning device possessing both water and weather resistance.

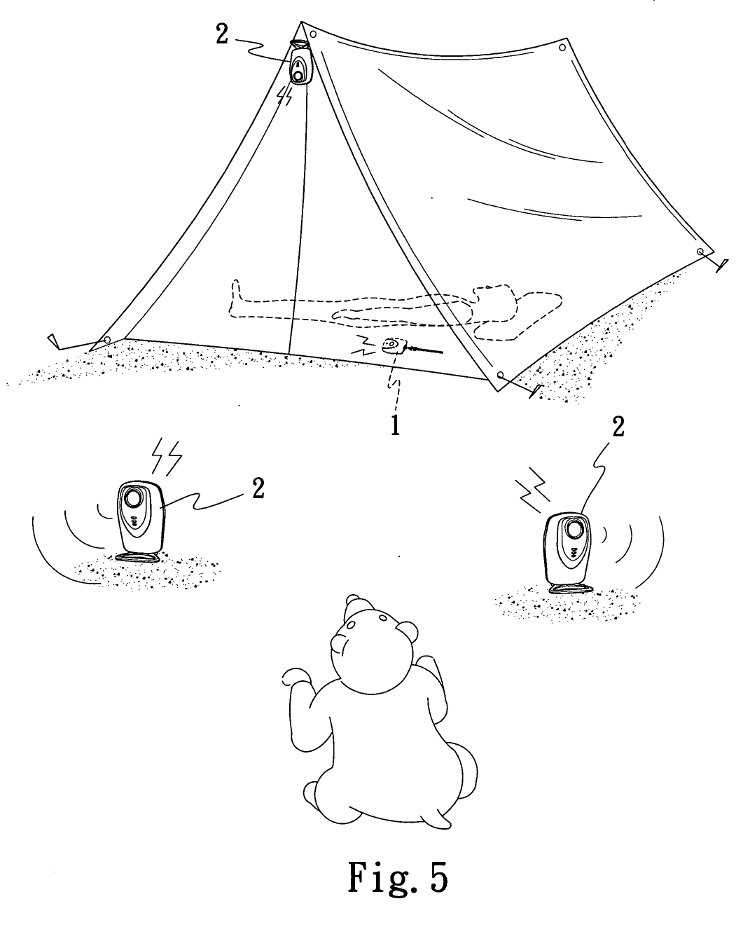

Refer to FIGS. 1 and 3, showing 3-D prospective views of outlooks of a remote-control device and an alarm device respectively in accordance with preferred embodiments of the present invention. FIG. 5 illustrates an environmental view of how those devices of the present invention can be utilized according to one of practical examples. The alarm device 2 shall be re-set before it is utilized. Once batteries are inserted into the electrical source 27 of the alarm device 2 when the device is in the re-set process, the illuminator 252 is immediately emitted flashing light to indicate that the alarm device 2 is into a process of waiting to learn. During this process of waiting to learn, the remote-control device 1 is taken out and a re-set signal is sent out from the launching device 125 to the alarm device 2 by pressing the key unit 123 in order to allow the illuminator 122 emitting light and coming into contact with the launching device 125 to release the re-set signal. The receiver 23 of the alarm device 2 receives the re-set signal from the launching device 125, the alarm unit 251 of the warning unit 25 produces a sound signal to indicate the user that the alarm device 2 is re-set successfully. The re-set process is thus completed.

Once the alarm device 2 is re-set successfully, the user can places the alarm device 2 in accordance with his/her needs or the circumstantial conditions to give warning. When the alarm device 2 is utilized in an outdoor activity or sport, the user can position the alarm device 2 within a boundary of a region of the activity or the sport took place. When positioning the alarm device 2, the supporting stand 22 can be utilized to locate and support the cover body 21 of the alarm device 2 on a flat surface. The alarm device 2 can also be positioned on a top part of a tent or on a tree by a hanging method. A plurality of alarm devices 2 of the present invention can be utilized to form a protective net according to the needs of the location of the active/sport region. Furthermore, the re-set signal that is launched by the remote-control device 1 of the present invention is a RF wireless signal. Therefore, whether the alarm device 2 is located on the flat surface or is hanged on the tent or on the tree, the objective of convenience can be achieved because of its setup can be done easily and quickly in accordance with the needs of the sport or the outdoor/wildlife activities. Once the alarm device 2 is positioned on a required location, the sensor 24 of the alarm device 2 utilizes a method of thermal reaction to sense the surrounding's conditions in a range of approximately 3-5 meters wide. When the sensor 24 of the alarm device 2 senses any heat source from a human being or an animal within the detected range, the sensor 24 will send out a contact signal to the warning unit 25 in order to trigger simultaneously the alarm unit 251 producing warning sound and the illuminator 252 emitting flash light to send warning signals to the user indicating that there is an object approaching.

As the above-mentioned, the present invention provides an improving design of a portable radar alarm device that sorts out those defects of the conventional alarm device. The present invention provides an alarm device controlled by a re-set remote-control device can be setup quickly and easily at a location of outdoor sports or wildlife activities. Once the sensor of the alarm device senses any abnormal condition, a warning signal will be sent to the user to warn the potential danger. Thus, the present invention provides an improving design of an alarm device that is more practical to accompany the needs of outdoor activities, it is convenient to use and easy to setup.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A portable radar alarm device having water and weather resistance, comprising:
a remote-control device, having a cover body and a launching device, wherein the launching device is located with the cover body and can launch a re-set signal; and
at least a warning device, wherein the warning device further comprises a supporting stand located at one end of the cover boy, a receiver located inside the cover boy and is utilized to received the re-set signal from the launching device, a sensor and warning unit, wherein the sensor and the warning unit are utilized to sense outdoor conditions and send out a warning signal to a user when there is any abnormal condition.

2. The portable radar alarm device of claim 1, wherein the cover body of the alarm device further comprises an upper cover and a bottom cover, a waterproof ring is located between the upper cover and the bottom cover.

3. The portable radar alarm device of claim 1, wherein the launching device further comprises an electrical circuit board, a launching unit located on the electrical circuit board, a key unit, an illuminator and an electrical source, the key unit and the illuminator are exposed outside of a surface area of the cover body.

4. The portable radar alarm device of claim 1, wherein a hooking ring is located at one end of the cover body of the alarm device.

5. The portable radar alarm device of claim 1, wherein the cover body further comprises a connecting portion that is utilized for connecting with the supporting stand and is located at one end of the bottom cover.

6. The portable radar alarm device of claim 1, wherein the cover body of the alarm device comprises an electrical source that is utilized to connect to the receiver, the sensor and the warning unit.

7. The portable radar alarm device of claim 1, wherein the receiver, the sensor and the warning unit are located on an electrical circuit board, a pressed switch is positioned on the electrical circuit board.

8. The portable radar alarm device of claim 1, wherein the warning unit comprises an alarm unit and an illuminator.
